(19) United States
(12) Patent Application Publication
(10) Pub. No.: US 2006/0163504 A1
(43) Pub. Date: Jul. 27, 2006

(54) Identification sensor

(75) Inventors: Jun Fujimoto, Tokyo (JP); Kazuei Yoshioka, Tokyo (JP)

Correspondence Address: LEYDIG VOIT & MAYER, LTD, 700 THIRTEENTH ST. NW, SUITE 300, WASHINGTON, DC, 20005-3960, US

(73) Assignees: ARUZE CORP., TOKYO (JP); SETA CORP., TOKYO (JP)

(21) Appl. No.: 10/543,168

(22) PCT Filed: Jan. 21, 2004
(86) PCT No.: PCT/JP04/00487

§ 371 Date: Feb. 28, 2006

(30) Foreign Application Priority Data
Jan. 23, 2003 (JP) 2003-14703

(51) Int. Cl. G01N 21/88

(52) U.S. Cl. 250/559.45

(57) ABSTRACT

A discrimination sensor includes a light emitting device individually emitting sensing light beams onto a surface of an object, such as a bill and having a sensing area that is wide in a direction perpendicular to a scanning direction; and a light detecting device assuring a light detecting area that is wide in a direction perpendicular to the scanning direction and detecting light coming from a surface structure of the bill when the sensing light is emitted. The light emitting device and the light detecting device are integrated with each other.

### TECHNICAL FIELD

The present invention relates to a discrimination sensor having a function of discriminating an object at a high level.

### BACKGROUND ART

Hitherto, as disclosed in Japanese Patent No. 2896288 (see paragraphs 0007-0009), there has been known a discrimination sensor configured to recognize a surface structure of an object (for example, a complex pattern applied to the surface of a bill, an integrated circuit or the like) and also adapted to determine the authenticity, the accuracy and the like of the object. Usually, the discrimination sensor of this kind is disposed at a position corresponding to a characteristic part of the surface structure (or the pattern), which best reflects the characteristic of the object. The object and the discrimination sensor are made to perform relative movement. This causes the discrimination sensor to scan along the characteristic part of the surface structure. Then, sensing data obtained during the scan (that is, data plotted corresponding to the characteristic part of the surface structure) is compared with original data. Consequently, the authenticity, the accuracy and the like of the object are determined.

Meanwhile, the complex patterns of, for example, mass-produced bills, integrated circuits or the like are not applied to exactly the same position on the surface of each of the objects in such a way as to have the same shape. During the pattern is printed, a slight displacement, deformation or the like is caused by the influence of printing precision and machining accuracy. The conventional discrimination sensor is caused to scan in a pinspot condition in which a sensing area is extremely narrow. Even when a slight displacement or deformation of the pattern of the characteristic part occurs, sensing data obtained from the characteristic part largely varies.

More specifically, the discrimination sensor is fixedly positioned at a certain position. Thus, the position of the discrimination sensor is not adjusted according to the displacement, the deformation or the like of the pattern applied to the surface of the object. At all times, sensing data obtained from the pattern corresponding to a specific scanning line is plotted. Therefore, for instance, in a case where no displacement, deformation or the like of the pattern occurs, the sensing data obtained from the pattern corresponding to the specific scanning line is always matched with the original data. In contrast with this, even when a slight displacement, deformation or the like of the pattern applied to the specific scanning line occurs, sensing data obtained by the discrimination sensor becomes different from original data, regardless of the fact that the discrimination sensor scans the same scanning line. This is because of the facts that the conventional discrimination sensor is in the pinspot condition in which the sensing area is extremely narrow, and that when a slight displacement or deformation of the pattern occurs, the pattern of the characteristic part is off the sensing area. In this case, the discrimination sensor is in the same state as if this sensor scanned a different pattern part. The sensing data obtained from the different pattern part is compared with the original data. Consequently, the conventional discrimination sensor has the following problems. For example, in the case of determining the authenticity of a bill, a genuine bill is erroneously determined to be a forged bill. In the case of determining the accuracy of an integrated circuit, a completed product is erroneously determined to be a defective product.

### DISCLOSURE OF INVENTION

The invention is accomplished to solve such problems. One of objects of the invention is to provide a discrimination sensor having an excellent discriminating function, which is enabled to determine the authenticity, the accuracy and the like of an object correctly or accurately without being affected by a displacement, deformation or the like of a surface structure of the object.

According to the invention, there is provided a discrimination sensor 2 that optically detects a surface structure 6 of an object 4 by scanning along a surface of the object 4 in a scanning direction S1. The discrimination sensor includes: a light emitting device 8 that emits sensing light L to the surface of the object 4, the sensing light L having a sensing area E1 being wide in a direction perpendicular to the scanning direction S1; and a light receiving device 10 having a light receiving area E2 that receives light R generated on the surface structure 6 of the object 4 when the sensing light L is emitted, the light receiving area E2 configured to be wide in a direction perpendicular to the scanning direction S1. In the invention, the light emitting device may be configured to be able to individually emit plural sensing light beams (e.g., a near infrared light beam and a visible light beam) of wavelength bands differing from each other. The light receiving device is configured to be able to receive light beams generated on the surface structure of the object independently when the sensing light beams of wavelength bands differing from each other are individually emitted from the light emitting device. Further, the discrimination sensor may be provided with a computation/determination unit 12 adapted to perform a computation on a discrimination signal outputted from the light receiving device when receiving light generated on the surface structure of the object, and also adapted to determine whether or not a value represented by the discrimination signal is within a predetermined tolerance range.

According to the discrimination sensor, during the surface structure of the object is scanned, plural sensing light beams of wavelength bands differing from each other are individually emitted from the light emitting device. Light beams generated on the surface structure of the object at that time are converted by the light receiving device into a discrimination signal, which is then inputted to the computation/determination unit. Subsequently, the computation/determination unit determines whether or not a value represented by the discrimination signal is within a tolerance range.

According to the invention, there is provided a discrimination sensor that optically detects a surface structure 6 of an object 4 by scanning along a surface of the object 4 in a scanning direction S1. The discrimination sensor includes: a sensor unit 14 having an optical path opening 14a widely opened in a direction perpendicular to the scanning direction S1; a light emitter (for example 8a′, 8b′) that is provided in the sensor unit 14 and emits light; alight receiver 10 that is provided in the sensor unit 14 and receives light; and a focusing optical system (for example, 16a, 16b, 16c) that focuses the light emitted from the light emitter towards the optical path opening 14a, and focuses light that is incident into the sensor unit 14 through the optical path opening 14a to the light receiver 10.

According to such a discrimination sensor, a light beam emitted from the light emitter is focused by the focusing optical system to the optical path opening. Thereafter, the focused sensing light beams, the sensing area corresponding to each of which is wide in a direction perpendicular to a scanning direction, are focused on the surface of the object from the optical path opening. Then, light beams, which come from the surface structure of the object and are incident into the sensor unit through the optical path opening, are focused by the focusing optical system on the light receiver.

### BRIEF DESCRIPTION OF DRAWINGS

In the accompanying drawings:

FIG. 1A is a perspective view illustrating a state of use of a discrimination sensor according to the embodiment;

FIG. 1B is a perspective view illustrating a state in which sensing light is emitted from a light emitting device of the discrimination sensor according to a first embodiment by assuring a wide sensing area;

FIG. 1C is a perspective view illustrating a state in which the discrimination sensor moves along a scanning direction;

FIG. 1D is a plan view illustrating the discrimination sensor in which the light emitting device and a light receiving device are formed integrally with each other;

FIGS. 1E and 1F are plan views each illustrating a modification of the discrimination sensor in a state in which the light emitting device is constituted by two light emitting portions;

FIG. 2A is a view illustrating a tolerance range of sample data stored in a computation/determination unit of the discrimination sensor;

FIG. 2B is a perspective view illustrating a modification employing a semiconductor substrate on which a fine integrated circuit is pattern-printed;

FIGS. 2C and 2D are views each illustrating the configuration of the discrimination sensor in the case of using transmitted light;

FIG. 3A is a perspective view illustrating the configuration of a discrimination sensor according to a second embodiment;

FIGS. 3B to 3E are cross-sectional views, taken along line IIb-IIb shown in FIG. 3A, illustrating a sequence of scanning states in which light emitted from each of light emitters is focused by a focusing optical system from an optical path opening on an object, and in which light impinging upon the optical path opening from the object is focused on a light receiver by the focusing optical system.

FIG. 4 is a cross-sectional view, taken along line IV-IV shown in FIG. 3A, illustrating a state in which light impinging upon the optical path opening from the object is focused on a light receiver by the focusing optical system (a focusing lens portion);

FIGS. 5A and 5B are views illustrating a modification of the discrimination sensor and also illustrating a state in which light emitted from a single light emitting portion is focused by a focusing optical system from an optical path opening on an object, and in which light impinging upon the optical path opening from the object is focused on a light receiver by the focusing optical system; and

FIGS. 6A and 6B are views illustrating the configuration of a discrimination sensor in the case of using transmitted light.

In the figures, reference character 2 designates a discrimination sensor, reference character 4 designates an object, reference character 6 designates a surface structure, reference character 8 designates a light emitting device, reference character 10 designates a light receiving device, reference character E1 designates a sensing area, reference character E2 designates a light receiving area, reference character L designates sensing light, reference character R designates light generated on the surface structure, and reference character S1 designates a scanning direction.

### BEST MODE FOR CARRYING OUT THE INVENTION

Hereinafter, a discrimination sensor according to the invention is described with reference to the accompanying drawings.

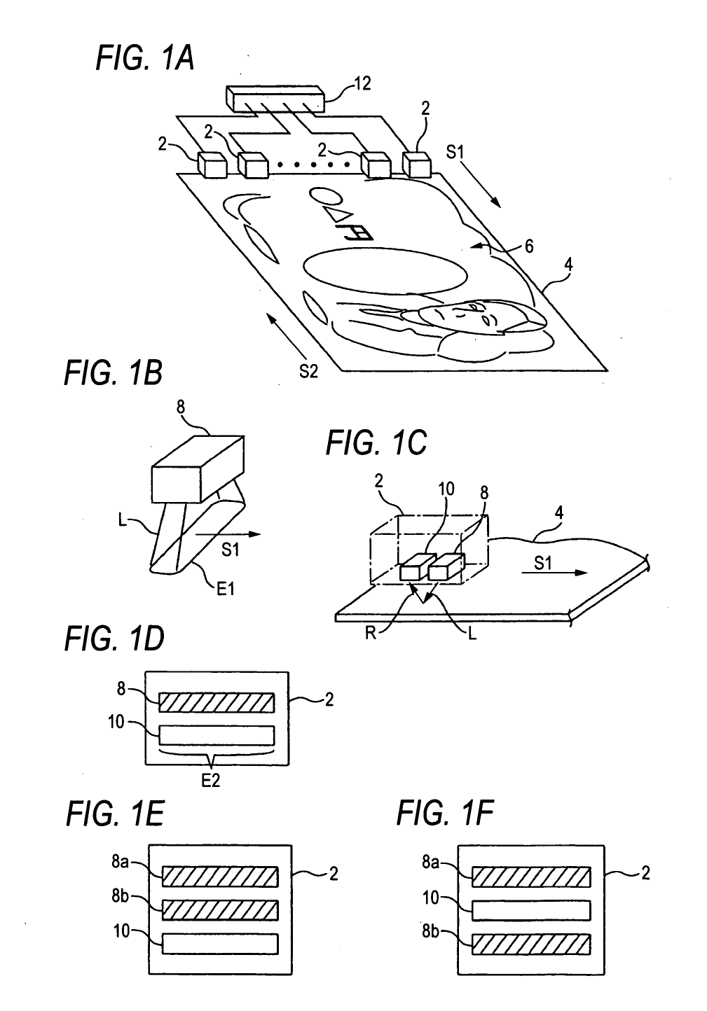

As shown in FIG. 1A, a discrimination sensor 2 according to the invention is enabled to optically detect a surface structure 6 of an object 4 by scanning along a surface of the object 4. In the description of each of the following embodiments, a bill (paper money) is employed as the object 4. A design of characters and figures printed on a surface of the bill 4 is adopted as the surface structure 6.

The discrimination sensors 2 are disposed at plural places in such a way as to be able to sense the surface structure by scanning along a characteristic part of the bill 4 serving as an object. FIG. 1A shows an apparatus configured so that plural discrimination sensors 2 are arranged at predetermined intervals along a transversal direction crossing the longitudinal direction of a bill 4, and scan in the longitudinal direction of the bill 4 to thereby sense the surface structure. Alternatively, the apparatus may be configured so that plural discrimination sensors 2 are disposed at predetermined intervals along the longitudinal direction of the bill 4 and scan in the transverse direction thereof to thereby sense the surface structure. The arrangement intervals and the number of the discrimination sensors 2 are optionally set according to the shape and the position of the characteristic part of the bill 4. Therefore, the arrangement intervals and the number of the discrimination sensors 2 are not limited to specific values. Further, a part, which is effective in specifying or identifying an object (that is, the bill 4), is designated as the characteristic part of the bill 4, which is the object.

Furthermore, a method of moving each of the discrimination sensors 2 in a scanning direction designated by an arrow S2, and a method of moving the bill 4 in a scanning direction designated by an arrow S2 are considered as a method of causing the plural discrimination sensors 2 to scan along the characteristic part of the bill 4. In the description of each of the following embodiments, the method of moving each of the discrimination sensors 2 in the scanning direction S (see FIG. 1C) is employed by way of example. Incidentally, in any such method, existing moving devices can be utilized as means for moving the discrimination sensors 2 and the bill 4. Thus, the description of such means is omitted herein. In this case, a method of controlling movement timings, with which the discrimination sensors 2 are respectively moved, in such a way as to simultaneously move the discrimination sensors 2 is commonly used. However, the method of moving the discrimination sensors 2 is not limited thereto. The apparatus may employ a method of moving the discrimination sensors 2 by individually controlling and shifting the movement timings thereof in such a way as to relatively differ from one another.

FIGS. 1B and 1C show the configuration of the discrimination sensor 2 according to the first embodiment of the invention. Such a discrimination sensor 2 includes a light emitting device 8 adapted to emit sensing light L, the sensing area E1 corresponding to which extends in a direction perpendicular to the scanning direction S1 is wide, toward the surface of the object (or bill) 4, and also includes a light receiving device 10 adapted to receive light R generated on the surface structure 6 of the bill 4 when the sensing light L is emitted, and also adapted to assure a wide light receiving area E2 in a direction perpendicular to the scanning direction S1. The light emitting device 8 and the light receiving device 10 are formed integrally with each other in the discrimination sensor 2 (see FIG. 1D).

In the first embodiment, the light R generated on the surface structure 6 of the bill 4 is assumed to be reflection light reflected from the surface of the bill 4 when the sensing light L is emitted. The reflection light has optical properties (change in optical power, scattering, change in wavelength, and the like), which vary according to the shape and the position of the surface structure 6, or to the kind (for example, magnetic ink) and the shades of ink used for printing the surface structure 6.

The light emitting device 8 is configured to be able to individually emit plural sensing light beams L of wavelength bands differing from each other. The light receiving device 10 is configured to be able to sequentially receive light beams R generated on the surface structure 6 of the bill 4 when the sensing light beams L of wavelength bands differing from each other are individually emitted from the light emitting device 8. Incidentally, for example, a method of changing the oscillating frequency of the light emitting device 8 by changing the value of a voltage applied to the light emitting device 8 is employed as a method of causing the light emitting device 8 to individually emit plural sensing light beams L of wavelength bands differing from each other.

In this case, it is preferable that one of the sensing light beams L of wavelength bands differing from each other is set in the band of wavelengths from substantially 700 nm to substantially 1600 nm, and that the other sensing light beam L is set in the band of wavelengths from substantially 380 nm to substantially 700 nm. More preferably, one of the sensing light beams L of wavelength bands differing from each other is set in the band of wavelengths from substantially 800 nm to substantially 1000 nm, while the other sensing light beam L is set in the band of wavelengths from substantially 550 nm to substantially 650 nm. Incidentally, in this embodiment, one of the sensing light beams L of wavelength bands differing from each other is set in the band of a wavelength of substantially 940 nm, while the other sensing light beam L is set in the band of a wavelength of substantially 640 nm, by way of example. Incidentally, for convenience of description, the sensing light beam L of the band of wavelengths from substantially 700 nm to substantially 1600 nm is referred to as a near infrared light beam. The sensing light beam L of the band of wavelengths from substantially 700 nm to substantially 1600 nm is referred to as a near infrared light beam. The sensing light beam L of the band of wavelengths from substantially 380 nm to substantially 700 nm is referred to as a visible light beam.

For example, a light-emitting diode (LED), a semiconductor laser or the like can be employed as the light emitting device 8 configured to realize light beams of such wavelength bands. However, as long as the light beams of the aforementioned wavelength bands can be realized, other kinds of light emitting devices may be used as the light emitting device 8.

Preferably, for instance, a method of alternately emitting a near infrared light beam and a visible light beam with predetermined timings is employed as a method of causing the light emitting device 8 to emit sensing light beams L (that is, a near infrared light beam and a visible light beam) of wavelength bands differing from each other. In this case, the timing with which each of the near infrared light beam and the visible light beam is emitted, is optionally set according to the moving speed of each of the discrimination sensors 2, and to the kind of the object (or the bill) 4. Thus, the timing is not limited to a specific timing. In this embodiment, the near infrared light beam and the visible light beam are alternately emitted with the predetermined timing. However, as long as the surface structure 6 of the object (or the bill) 4 can optically be sensed, other methods may be employed.

According to the aforementioned discrimination sensors 2, during each of the discrimination sensors 2 is moved along the scanning direction S1, the light emitting device 8 alternately emits a near infrared light beam and a visible light beam with the predetermined timing. At that time, the light receiving device 10 sequentially receives light beams R generated on the surface structure 6 of the bill 4 and outputs an electrical signal representing a voltage value (or an electric current value) corresponding to an amount of the received light beam, that is, a discrimination signal.

The discrimination sensor 2 has a computation/determination unit 12. Thus, a predetermined computation is performed on the discrimination signal, which is outputted from the light receiving device 10, in the computation/determination unit 12. Then, it is determined whether or not the value represented by the discrimination signal is within a predetermined tolerance range.

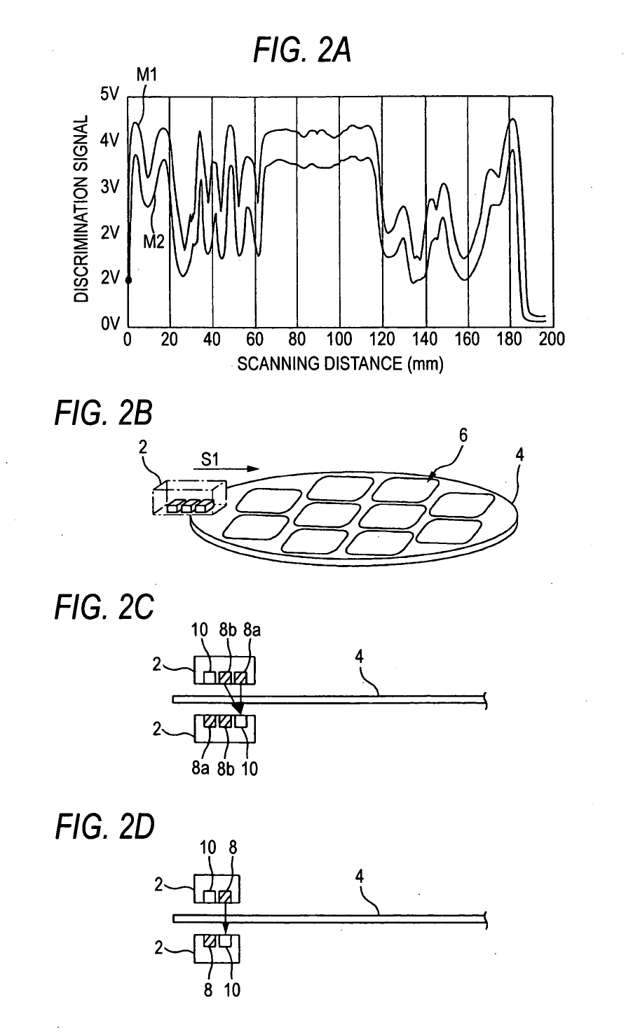

Preliminarily detected sample data is stored in the computation/determination unit 12. The sample data is constituted by data that is obtained by optically sensing the surface structure of a sample object (a genuine bill in a case where the object to be scanned is a bill) of the same kind as the kind of an object (or bill) 4 scanned by the discrimination sensor 2. Practically, many (for example, hundreds of) sample objects are prepared. Then, sensing data respectively obtained from the sample objects are detected. The sample data obtained at that time is detected as data, which represents a value having a certain range as shown in, for example, FIG. 2A, due to a displacement, deformation or the like of the surface structure. Incidentally, such sample data includes values represented by electrical signals (or digital signals) outputted from the light receiving device 10, all of which are plotted. In this case, a region between a “maximum line” M1, which connects points that correspond to maximum values represented by the sample data, and a “minimum line” M2, which connects points that correspond to minimum values represented by the sample data, is defined herein as a tolerance range.

It is determined according to a computation performed by the computation/determination unit 12 whether or not a value represented by the discrimination signal outputted from the light receiving device 10 is within the range defined between the “maximum line” M1 and the “minimum line” M2. Practically, when the bill 4, which is the object, is genuine, the values represented by the discrimination signals outputted from the light receiving device 10 are plotted along the region (that is, the tolerance range) defined between the “maximum line” M1 and the “minimum line” M2. In contrast with this, when the value represented by the discrimination signal outputted from the light receiving device 10 is out of the tolerance range, it is determined that the bill 4 is a forged bill. In this case, the reflection light R generated on the surface structure 6 of a new bill 4 differs in optical property (or light quantity) from that generated on the surface structure 6 of an old bill 4. However, the light quantity of the reflection light R (thus, the signal strength of the discrimination signal) differs only slightly between the new bill and the old bill. Thus, there is no need for setting the range between the “maximum line” M1 and the “minimum line” M2, which are obtained from the preliminarily detected sample data, at a large value. Consequently, determination accuracy can be enhanced.

As described above, in accordance with the discrimination sensor 2 according to the first embodiment, the authenticity of the object can be determined correctly without being affected by a displacement, deformation or the like of the surface structure of the object (the bill, in the embodiment) by employing the sensing light adapted so that the corresponding wide sensing area extending in a direction perpendicular to the scanning direction is assured. Also, the surface structure 6 of the object can be determined with high-level discrimination ability by sensing the surface structure by individually emitting plural sensing light beams L of wavelength bands differing from each other.

Incidentally, although the bill 4 is employed as the object in the aforementioned embodiment, the object is not limited thereto. For instance, as shown in FIG. 2B, a semiconductor substrate, on which a fine integrated circuit is pattern-printed, may be employed as the object 4. The surface structure 6 in this case is the pattern-printed integrated circuit. With such a configuration, the accuracy of the integrated circuit 6 can be determined. Thus, the yield of products can be enhanced.

Further, although the aforementioned embodiment is configured so that the light emitting device 8 singly and individually emits sensing light beams (that is, a near infrared light beam and a visible light beam) L of wavelength bands differing from each other (with the predetermined timing alternately). The light emitting device according to the invention is not limited thereto. For example, as shown in FIGS. 1E and 1F, the light emitting device 8 may be constituted by plural (or two) light emitting portions 8a and 8b each adapted to individually emit sensing light beams (that is, a near infrared light beam and a visible light beam) L of wavelength bands differing from each other. For instance, one of the light emitting portions 8a emits a near infrared light beam, while the other light emitting portion 8b emits a visible light beam.

Although an example of the discrimination sensor 2 using the reflection light R has been described in the description of the embodiment, the discrimination sensor 2 according to the invention is not limited thereto. For example, as shown in FIGS. 2C and 2D, the discrimination sensor 2 using transmitted light may be employed. In this case, paired discrimination sensors 2 are disposed across the object 4 in such a way as to be opposed to each other. The light receiving function of the light receiving device 10 of one of the discrimination sensors 2 is stopped. The light emitting function of the light emitting device 8 (thus, each of the light emitting portions 8a and 8b) of the other discrimination sensor 2 is stopped. Consequently, sensing light beams (that is, a near infrared beam and a visible light beam) emitted from the light emitting device 8 (thus, each of the light emitting portions 8a and 8b) of one of the discrimination sensors 2 are transmitted by the object 4. Thereafter, the transmitted light beams are received by the light receiving device 10 of the other discrimination sensor 2. Incidentally, in the case of using the discrimination sensor 2 of the transmission type, the object 4 is limited to those having optical transparency.

Next, a discrimination sensor according to a second embodiment of the invention is described hereinbelow with reference to the accompanying drawings. In the aforementioned first embodiment, the light emitting device 8 is configured to have a wide rectangular shape so as to emit sensing light beams L, the sensing area E1 corresponding to each of which extends in a direction perpendicular to the scanning direction S1 and is assured to be wide. The light receiving area E2 of the light receiving device 10 is assured in such a way as to be wide in a direction perpendicular to the scanning direction S1 so as to receive light R generated on the surface structure 6 of the bill 4 when such sensing light beams L are emitted. In contrast with this, in the second embodiment, commercially available light emitters (8a′ and 8b′) and commercially available light receivers 10′ are used, as will be described later. Light beams radially emitted from each of the light emitters (8a′ and 8b′) are set by a focusing optical system (16a and 16b) to be the sensing light beams L, the sensing area E1 corresponding to each of which is assured to be wide in a direction perpendicular to the scanning direction S1. Light R generated on the surface structure 6 of the bill 4 is focused on the light receiver 10′ by the focusing optical system (16c).

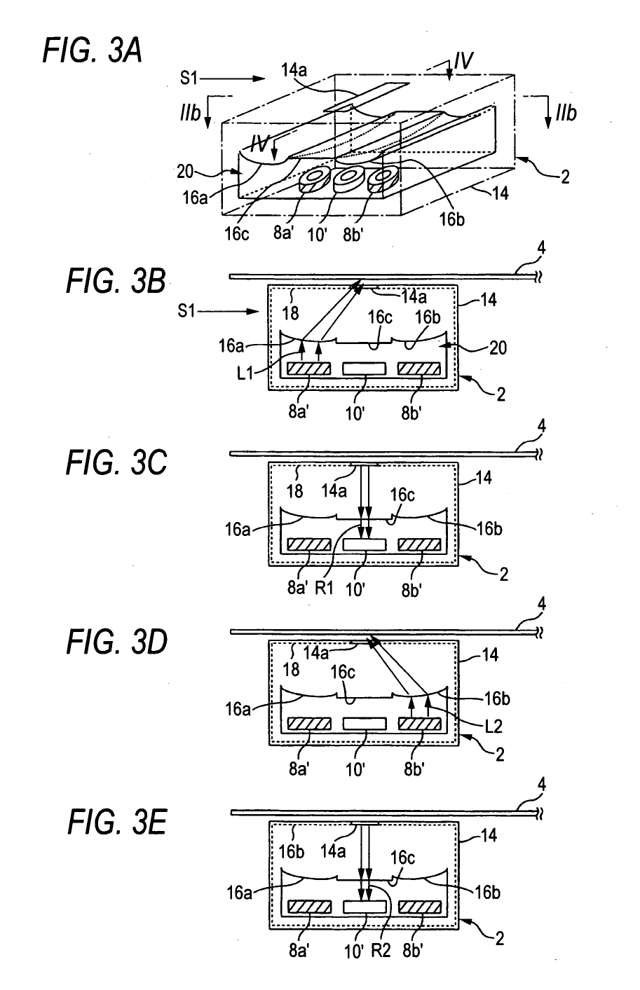

As shown in FIGS. 3A to 3E, the discrimination sensor 2 according to this embodiment is provided with a sensor unit 14 having an optical path opening 14a widely opened in a direction perpendicular to the scanning direction S1. In the sensor unit 14, light emitters (for example, 8a′ and 8b′) each adapted to emit predetermined light, and a focusing optical system (for instance, 16a, 16b, and 16c) formed integrally with the sensor unit 14 are provided. The focusing optical system (16a, 16b, and 16c) focuses light emitted from the light emitters (8a′ and 8b′) toward the optical path opening 14a and also focuses light, which is incident into the sensor unit 14 through the optical path opening 14a, toward the light receiver 10′.

In this case, the light emitted from the light beams emitters (8a′ and 8b′) are focused by the focusing optical system (16a, 16b, and 16c) to the optical path opening 14a. Thereafter, the focused light beams are used as the sensing light beams (L1, L2), the corresponding sensing area (for example, the sensing area designated by reference character E1 shown in FIG. 1B) of each of which is assured in such a way as to be wide in a direction perpendicular to the scanning direction S1. The sensing light is focused on the surface of the object (the bill, in the embodiment) 4 from the optical path opening 14a. Light beams (R1, R2) generated on the surface structure 6 (see FIG. 1A) of the bill 4 are incident into the sensor unit 14 through the optical path opening 14a. Subsequently, the incident light beams are focused by the focusing optical system (16a, 16b, and 16c) onto the light receiver 10′.

In the embodiment, the predetermined light beams emitted from the light emitters (8a′ and 8b′) is assumed to be sensing light beams (that is, a near infrared light beam L1 and a visible light beam L2 (to be described later)) of wavelength bands differing from each other. Further, the predetermined light beams received by the light receiver 10′ is assumed to be light beams (R1, R2) generated on the surface structure of the bill 4.

In this case, the light beams (R1, R2) generated on the surface structure of the bill 4 is assumed to be reflection light reflected from the surface of the bill 4 when the sensing light beams L1, L2) are emitted. The reflection light has optical properties (change in optical power, scattering, change in wavelength, and the like), which vary according to the shape and the position of the surface structure, or to the kind (for example, magnetic ink) and the shades of ink used for printing the surface structure.

Although the sensor unit 14 is shaped substantially like a rectangular as shown in the figures, the sensor unit 14 may have any other shape, as long as this shape does not hinder the scanning. The optical path opening 14a is formed in a part of the sensor unit 14 of such a shape. Light shielding processing is performed on the surface of the sensor unit 14, which is other than the optical path opening 14a.

As an example of the light shielding processing, a light shielding portion 18 is formed on the surface of the sensor unit 14 according to this embodiment, which is other than the optical path opening 14a, (integrally therewith). For instance, a reflecting mirror, which reflects outside light (or disturbance light), or a polarizing plate can be disposed on the light shielding portion 18. Alternatively, a black member having a property, which prevents outside light from being incident into the sensor unit 14, can be disposed thereon. Any other configuration may be employed, as long as the configuration prevents outside light from being incident into the sensor unit, and optional light shielding processing can be applied thereto.

The sensor unit 14 and the focusing optical system (16a, 16b, and 16c) are formed integrally with each other by using a transparent material (for example, plastics, such as a transparent resin, transparent glass or the like). The light emitters (8a′ and 8b′) and the light receiver 10′ are provided in such a way as to face the focusing optical system (16a, 16b, and 16c). Practically, the sensor unit 14 is provided with a cavity 20 formed by hollowing a part of the inside thereof. The light emitters (8a′ and 8b′) and the light receiver 10′ are provided in this cavity 20 in such a way as to face the focusing optical system (16a, 16b, and 16c) In the embodiment, the light emitters (8a′ and 8b′ include plural (two in this embodiment) light emitting portions 8a′ and 8b′ each adapted to emit sensing light beams (a near infrared light beam L1 and a visible light beam L2) of the wavelength bands differing from each other. For example, one of the light emitters 8a′ emits a near infrared light beam L1, while the other light emitter 8b′ emits a visible light beam L2.

Commercially available light emitting diodes (LEDs), semiconductor lasers or the like may be employed as the light emitters 8a′ and 8b′. However, as long as the light beams of the aforementioned wavelength bands can be realized, other kinds of light emitting devices may be used as the light emitting portions.

Conditions for setting the wavelength bands of the sensing light beams (the near infrared light beam L1 and the visible light L2) and timing, with which the light beams are emitted, are similar to those in the case of the first embodiment. Therefore, the description thereof is omitted herein.

For example, a photodiode, a phototransistor, a photothyristor or the like, which are commercially available, may be employed as the light receiver 10′.

Further, the focusing optical system includes focusing lenses 16a, 16b, and 16c formed on a side surface (that is, the surface at the side of the cavity 20) opposed to the two light emitting portions 8a′ and 8b′ and the light receptor 10′. Each of the focusing lenses 16a, 16b, and 16c extends toward a direction perpendicular to the scanning direction S1 (that is, toward a direction parallel to the optical path opening 14a). The shape of the cross-section of each of these focusing lens portions is curved convexly toward the light emitting portions 8a′ and 8b′ and the light receiver 10′. For example, the curvature of the focusing lens 16a is set so that the near infrared light beam L1 emitted from the light emitting portion 8a′ is focused on the bill 4 through the optical path opening 14a. On the other hand, the curvature of the focusing lens 16b is set so that the visible light beam L2 emitted from the light emitting portion 8b′ is focused on the bill 4 through the optical path opening 14a.

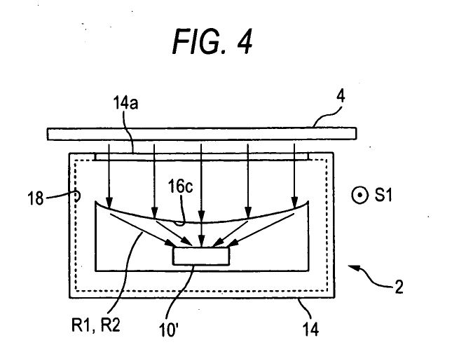

Furthermore, the curvature of the focusing lens 16c is set so that the light, which is incident thereinto through the optical path opening 14a (light beams (R1 and R2) generated on the surface structure of the bill 4), is focused on the light receiver 10′. Practically, the focusing lens 16c has a flat lens surface (see FIG. 3) extending along the scanning direction S1, and also has a surface (see FIG. 4) convexly curved toward the light receiver 10′ in a direction perpendicular to the scanning direction S1. Consequently, the light having been incident thereto through the optical path opening 14a (that is, the light beams (R1 and R2) generated on the surface structure of the bill) and corresponding to a wide light receiving area is converged toward the light receiver 10′ by the focusing lens 16c and is focused on a light receiving surface (not shown) of the light receiver 10′ (see FIGS. 3C, 3E and 4).

During moving on the bill 4 along the scanning direction S1, the aforementioned discrimination sensor 2 simultaneously causes the light emitting portions 8a′ and 8b′ to alternately emit a near infrared light beam L1 and a visible light beam L2 with predetermined timing.

In this case, first, the near infrared light beam L1 emitted from the light emitting portion 8a′ is focused by the focusing optical system (that is, the focusing lens) 16a to the optical path opening 14a. Then, the light passes through the optical path opening 14a. Thus, a sensing light beam L1 is emitted so that the corresponding sensing area is assured in such a way as to be wide in a direction perpendicular to the scanning direction S1 (for example, the sensing area designated by reference character E1 shown in FIG. 1B). Subsequently, the sensing light L1 is focused on the bill 4 (see FIG. 3B). Then, light reflected from the bill 4 at that time (that is, a light beam R1 generated on the surface structure of the bill 4) passes through the optical path opening 14a. Subsequently, the reflected light is focused on the light receiver 10′ by the focusing optical system (that is, the focusing lens) 16c (see FIG. 3C). When receiving the light R1 generated on the surface structure of the bill 4, the light receiver 10′ outputs an electrical signal, that is, a discrimination signal, which represents a voltage value (or an electric current value) corresponding to an amount of received light, to the computation/determination unit 12 (see FIG. 1A).

Subsequently, the near infrared light L2 emitted from the light emitting portion 8b′ is focused by the focusing optical system (that is, the focusing lens) 16b to the optical path opening 14a. Then, this light passes through the optical path opening 14a. Thus, sensing light L2 is emitted so that the corresponding sensing area is assured in such a way as to be wide in a direction perpendicular to the scanning direction S1. The sensing light L2 is focused on the bill 4 (see FIG. 3D). Light reflected from the bill 4 at that time (that is, light R2 generated on the surface structure of the bill 4) passes through the optical path opening. 14a. Thereafter, this light is focused by the focusing optical system (that is, the focusing lens) 16c on the light receiver 10′ (see FIG. 3E). When receiving the light R2 generated on the surface structure of the bill 4, the light receiver 10′ outputs an electrical signal, which represents a voltage value (or an electric current value) corresponding to an amount of received light, to the computation/determination unit 12 (see FIG. 1A)

The computation/determination unit 12 performs a predetermined computation on the value represented by the discrimination signal outputted from the light receiver 10′. Then, the computation/determination unit 12 determines whether or not the value represented by the discrimination signal is within a predetermined tolerance range. That is, the computation/determination unit 12 determines whether or not the value represented by the discrimination signal is within a region (that is, the tolerance range) between the “maximum line” M1 and the “minimum line” M2, which are obtained from the sample data, as shown in FIG. 2A. Practically, in a case where the values represented by the discrimination signals, which are outputted from the light receiver 10′, are plotted along the region defined between the “maximum line” M1 and the “minimum line” M2 (that is, the tolerance range), the bill 4 is determined to be a genuine one. In contrast with this, in a case where the values represented by the discrimination signals, which are outputted from the light receiver 10′, are not plotted along the region defined between the “maximum line” M1 and the “minimum line” M2 (that is, the tolerance range), the bill 4 is determined to be a forged one.

Incidentally, the remaining beams and the operation of the computation/determination unit 12 are similar to those of the computation/determination unit 12 of the first embodiment. Thus, the description thereof is omitted herein.

As described above, in accordance with the discrimination sensor 2 according to the second embodiment, sensing light beams similar to that of the first embodiment (that is, the sensing light beams, the sensing area corresponding to each of which is assured to be wide in the direction perpendicular to the scanning direction S1) can be obtained by using the commercially available inexpensive light emitters (8a′ and 8b′) and the commercially available inexpensive light emitter 10′. Thus, the configuration of the sensor can be simplified. The manufacturing cost thereof can considerably be reduced. Incidentally, other advantages of the second embodiment are similar to those of the first embodiment. Therefore, the description thereof is omitted herein.

Although the bill 4 is employed as the object in the aforementioned embodiments, the object is not limited thereto. For example, as shown in FIG. 2B, a semiconductor substrate, on which a fine integrated circuit is pattern-printed, may be employed as the object 4. The surface structure 6 in this case is the pattern-printed integrated circuit. With such a configuration, the accuracy of the integrated circuit can be determined. Thus, the yield of products can be enhanced.

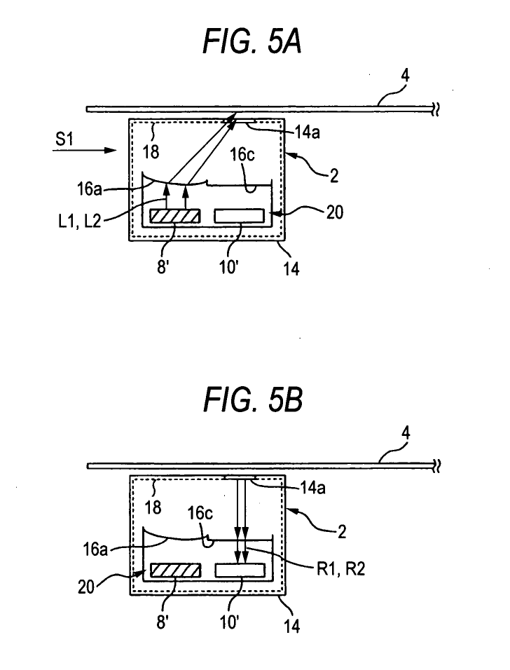

Further, although the light emitters of the second embodiment are respectively constituted by plural (two, in this embodiment) light emitting portions 8a and 8b each adapted to individually emit sensing light beams (that is, a near infrared light beam and a visible light beam) L of wavelength bands differing from each other. However, the light emitters according to this embodiment are not limited thereto. For example, as shown in FIGS. 5A and 5B, the light emitter may be constituted by a single light emitter enabled to individually emit sensing light beams (that is, a near infrared light beam and a visible light beam) L of wavelength bands differing from each other (with the predetermined timing alternately).

In this case, for example, a method of changing the oscillating wavelength of the light emitter 8′ by switching the value of the voltage applied to the light emitter 8′ can be employed as the method of causing the light emitter 8′ to individually emit plural sensing light beams of wavelength bands differing from each other.

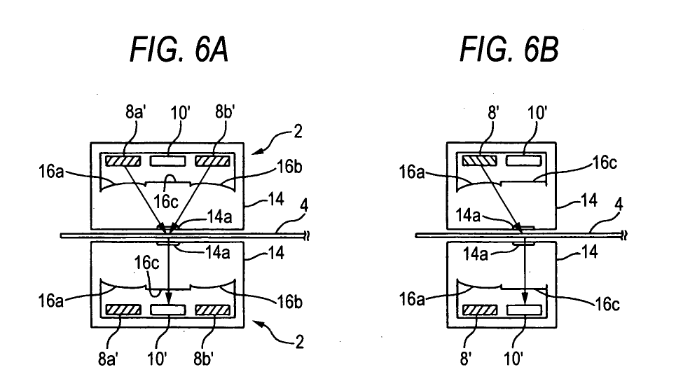

Furthermore, although an example of the discrimination sensor 2 using reflection right (R1, R2) has been described in the description of the embodiment shown in FIGS. 3A to 5B, the discrimination sensor according to the invention is not limited thereto. For instance, as shown in FIGS. 6A and 6B, the discrimination sensor 2 using transmitted light may be employed. In this case, paired discrimination sensors 2 are disposed across the object 4 in such a way as to be opposed to each other. The light receiving function of the light receiver 10′ of one of the discrimination sensors 2 is stopped. The light emitting function of the light emitter 8′ (thus, each of the light emitting portions 8a′ and 8b′) of the other discrimination sensor 2 is stopped. Consequently, sensing light beams (that is, a near infrared beam and a visible light beam) emitted from the light emitter 8′ (thus, each of the light emitting portions 8a and 8b) of one of the discrimination sensors 2 are transmitted by the object 4. Thereafter, the transmitted light beams are received by the light receiver 10′ of the other discrimination sensor 2. Incidentally, in the case of using the discrimination sensor 2 of the transmission type, the object 4 is limited to those having optical transparency.

Additionally, although the focusing lens 16c has a flat lens surface (see FIGS. 3A to 3E) in a direction along the scanning direction in the embodiment shown in FIGS. 3A to 5B, the lens surface may be convexly curved toward the light receiver 10′ in the direction along the scanning direction S1. In this case, all the light having been incident thereto through the optical path opening 14a (that is, the light beams (R1 and R2) generated on the surface structure of the bill 4) and corresponding to a wide light receiving area is converged toward the light receiver 10′ by the focusing lens 16c and is focused on a light receiving surface (not shown) of the light receiver 10′.

Although the invention has been described in detail with reference to specific embodiments thereof, it is apparent to those skilled in the art that various alterations and modifications can be made without departing from the spirit and scope of the invention.

The present application is based on JP-2003-014703, filed Jan. 23, 2001, the entire contents of which are hereby incorporated by reference.

### INDUSTRIAL APPLICABILITY

According to the invention, the authenticity, the accuracy and the like of an object can be determined correctly or accurately without being affected by a displacement, deformation or the like of a surface of the object by employing the sensing light adapted so that the corresponding sensing area extending in a direction perpendicular to the scanning direction is assured. Also, the surface structure of the object can be determined with high-level discrimination ability by sensing the surface structure by individually emitting plural sensing light beams of wavelength bands differing from each other.

1. A discrimination sensor that optically detects a surface structure of an object by scanning along a surface of the object, the discrimination sensor comprising:
a light emitting device that emits sensing light to the surface of the object, the sensing light having a sensing area being wide in a direction perpendicular to the scanning direction; and
a light receiving device having a light receiving area that receives light generated on the surface structure of the object when the sensing light is emitted, the light receiving area configured to be wide in a direction perpendicular to the scanning direction.

2. The discrimination sensor according to claim 1, wherein the light emitting device and the light receiving device are integrally provided.

3. The discrimination sensor according to claim 1, wherein the light emitting device individually emits a plurality of sensing light beams having wavelength bands that differ from each other; and
wherein the light receiving device receives lights generated on the surface structure of the object independently when the plurality of sensing light beams are individually emitted.

4. The discrimination sensor according to claim 3, wherein the light receiving device sequentially receives lights generated on the surface structure of the object when the plurality of sensing light beams are individually emitted.

5. The discrimination sensor according to claim 1, wherein the light emitting device has a plurality of light emitting portions that individually emit sensing light beams respectively, the sensing light beams having wavelength bands that differ from each other; and
wherein the light receiving device receives lights generated on the surface structure of the object independently when the sensing light beams are individually emitted from the plurality of light emitting portions.

6. The discrimination sensor according to claim 5, wherein the light receiving device sequentially receives lights generated on the surface structure of the object when the plurality of sensing light beams are individually emitted from the plurality of light emitting portions.

7. The discrimination sensor according to claim 3, wherein the plurality of sensing light beams includes a sensing light beam having a wavelength band in a range from substantially 700 nm to substantially 1600 nm, and a sensing light beam having a wavelength band in a range from substantially 380 nm to substantially 700 nm.

8. The discrimination sensor according to claim 3, wherein the plurality of sensing light beams includes a sensing light beam having a wavelength band in a range from substantially 800 nm to substantially 1000 nm, and a sensing light beam having a wavelength band in a range from substantially 550 nm to substantially 650 nm.

9. The discrimination sensor according to claim 3, wherein the plurality of sensing light beams includes a sensing light beam in a band having a wavelength of substantially 940 nm, and a sensing light beam in a band having a wavelength of substantially 640 nm.

10. The discrimination sensor according to claim 1 further comprising a computation/determination unit that performs a computation on a discrimination signal outputted from the light receiving device when lights generated on the surface structure of the object is received, and determines whether or not the discrimination signal is within a predetermined tolerance range.

11. A discrimination sensor that optically detects a surface structure of an object by scanning along a surface of the object, the discrimination sensor comprising:
a sensor unit having an optical path opening widely opened in a direction perpendicular to the scanning direction;
a light emitter that is provided in the sensor unit and emits light;
a light receiver that is provided in the sensor unit and receives light; and
a focusing optical system that focuses the light emitted from the light emitter towards the optical path opening, and focuses light that is incident into the sensor unit through the optical path opening to the light receiver,
wherein the focusing optical system focuses the light emitted from the light emitter towards the optical path opening and onto the surface of the object as a sensing light having a sensing area being wide in a direction perpendicular to the scanning direction, and
wherein the focusing optical system focuses light generated on the surface structure of the object and is incident into the sensor unit through the optical path opening to the light receiver.

12. The discrimination sensor according to claim 11, wherein the focusing optical system and the sensor unit are formed integrally provided.

13. The discrimination sensor according to claim 11, wherein the light emitter individually emits a plurality of sensing light beams having wavelength bands that differ from each other; and
wherein the light receiver receives lights generated on the surface structure of the object independently when the plurality of sensing light beams are individually emitted.

14. The discrimination sensor according to claim 13, wherein the light receiver sequentially receives lights generated on the surface structure of the object when the plurality of sensing light beams are individually emitted.

15.-16. (canceled)

17. The discrimination sensor according to claim 13, wherein the plurality of sensing light beams includes a sensing light beam having a wavelength band in a range from substantially 700 nm to substantially 1600 nm, and a sensing light beam having a wavelength band in a range from substantially 380 nm to substantially 700 nm.

18. The discrimination sensor according to claim 11, wherein the plurality of sensing light beams include a sensing light beam having a wavelength band in a range from substantially 800 nm to substantially 1000 nm, and a sensing light beam having a wavelength band in a range from substantially 550 nm to substantially 650 nm.

19. The discrimination sensor according to claim 11, wherein the plurality of sensing light beams includes a sensing light beam in a band having a wavelength of substantially 940 nm, and a sensing light beam in a band having a wavelength of substantially 640 nm.

20. The discrimination sensor according to claim 11 further comprising a computation/determination unit that performs a computation on a discrimination signal outputted from the light receiver when light generated on the surface structure of the object is received, and determines whether or not the discrimination signal is within a predetermined tolerance range.

21. The discrimination sensor according to claim 11, wherein
the sensor unit and the focusing optical system include a transparent material and are integrated with each other,
the light emitter and the light receiver face the focusing optical system, and
light shielding processing is performed on a surface of the sensor unit, other than the optical path opening.

22. The discrimination sensor according to claim 13, wherein the plurality of sensing light beams include a sensing light beam having a wavelength band in a range from substantially 800 nm to substantially 1000 nm, and a sensing light beam having a wavelength band in a range from substantially 550 nm to substantially 650 nm.

23. The discrimination sensor according to claim 13, wherein the plurality of sensing light beams includes a sensing light beam in a band having a wavelength of substantially 940 nm, and a sensing light beam in a band having a wavelength of substantially 640 nm.
